(19) United States
(12) Patent Application Publication
(10) Pub. No.: US 2007/0040873 A1
(43) Pub. Date: Feb. 22, 2007

(54) PRINTER CARTRIDGE CARRIER AND FASTENING MECHANISM THEREOF

(75) Inventor: Yi Xue, Jiangsu Province (CN)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: BENQ CORPORATION, Taoyuan Shien (TW)

(21) Appl. No.: 11/465,816

(22) Filed: Aug. 21, 2006

(30) Foreign Application Priority Data
Aug. 22, 2005 (TW) 94128647
Nov. 4, 2005 (TW) 94138859

(51) Int. Cl. B41J 2/17

(52) U.S. Cl. 347/84

(57) ABSTRACT

A fastening mechanism configured in a carrier of a printer is provided. The carrier includes a body and several partitions. An ink cartridge is disposed between every two partitions. The fastening mechanism fastens the ink cartridge in the printer. The fastening mechanism includes a magnetic body, a coil, an elastic member, and a fastener. The magnetic body is disposed on the carrier. The coil generates a magnetic force with respect to the magnetic body when power currents flow through. The elastic member is disposed on one end of the magnetic body for storing resilient energy. When the coil is at a power-off state, the magnetic force of the coil disappears and the elastic member releases the resilient energy for enabling the fastener to be tightly coupled with the ink cartridge, so that the user is unable to unload the ink cartridge under power-off.

This application claims the benefits of Taiwan applications Serial No. 94128647, filed Aug. 22, 2005, and Taiwan application Serial No. 94138859, filed Nov. 4, 2005, the subject matter of which are incorporated herein by reference.

### BACKGROUND OF THE INVENTION

1. Field of the Invention

The invention relates in general to a fastening mechanism of a printer cartridge, and more particularly to a self-fastened fastening mechanism of a printer cartridge.

2. Description of the Related Art

Printers have been widely applied in various fields such as offices, schools and laboratories. Printers are mainly categorized as laser printers and ink-jet printers.

For a printer whose ink cartridge is not equipped with a memory, the following problems would arise during the replacement of ink cartridge when the printer system is at a power-off state or when the printer system is not functioning normally:

1: The printer system is unable to detect the replacement message of the ink cartridge, so the replacement message is not recorded. When the printer is turned on next time, the printer may proceed with printing according to the parameters of previous record, causing printing quality to be deteriorated.

2: The new message may not be updated timely, leading to an incorrect calculation of ink level.

3: If the ink cartridge is not equipped with memory, the printer may not be able to determine whether the ink cartridge is of the same type and the printer system may store incorrect message of the ink cartridge, resulting in printing errors.

### SUMMARY OF THE INVENTION

It is therefore an object of the invention to provide a fastening mechanism of printer which prevents the user from replacing ink cartridge under power-off, thus avoiding associated errors if ink cartridge is replaced under power-off.

The invention achieves the above-identified object by providing a fastening mechanism configured in a carrier of a printer. The carrier includes a body and several partitions. An ink cartridge is disposed between every two partitions. The fastening mechanism is used for fastening the ink cartridge in the printer. The fastening mechanism includes a magnetic body, a coil, a first elastic member, a second elastic member, and a fastener. The magnetic body is disposed on the carrier. The coil is disposed with respect to the magnetic body. When the coil is at a power-on state, the coil generates an interactive force with respect to the magnetic body. The first elastic member generates an elastic deformation for storing a resilient energy when receiving the magnetic force generated by the coil and the magnetic body. When the coil is at a power-off state, the magnetic force of the coil disappears and the first elastic member releases the resilient energy for enabling the fastener to be tightly coupled with the ink cartridge, so that the user is unable to unload the ink cartridge under power-off.

The invention further achieves the above-identified object by providing a carrier. The carrier is disposed on a printer. The carrier includes a body, several partitions and at least a fastening mechanism. Several partitions are formed on the body. The fastening mechanism is disposed on the partitions. The fastening mechanism includes a magnetic body, a coil, a first elastic member, a second elastic member, and a fastener. The magnetic body is disposed on the carrier. The coil is disposed with respect to the magnetic body. The first elastic member generates an elastic deformation for storing a resilient energy when receiving the magnetic force generated by the coil and the magnetic body. The fastener is movably disposed in the carrier. The fastener is correspondingly coupled with the ink cartridge. When the coil is at a power-on state, the coil generates a magnetic force with respect to the magnetic body. The magnetic force causes the first elastic member to be deformed so as to store a resilient energy. The fastener is not tightly coupled with the ink cartridge. When the coil is at a power-off state, the magnetic force of the coil disappears and the first elastic member releases the resilient energy for enabling the fastener to be tightly coupled with the ink cartridge.

According to the printer carrier and the fastening mechanism thereof disclosed in the invention, the magnetic force of the coil disappears under power-off and the fastener is tightly coupled with the ink cartridge, so that the user is unable to unload the ink cartridge. The user can only process the replacement of ink cartridge during the power-on state. According to the above disclosure, printer will not show error messages in the wake of the replacement of ink cartridge or ink-jet head.

Other objects, features, and advantages of the invention will become apparent from the following detailed description of the preferred but non-limiting embodiments, The following description is made with reference to the accompanying drawings.

### BRIEF DESCRIPTION OF THE DRAWINGS

FIG. 1 is a three-dimensional diagram showing the carrier and the ink cartridges of a printer;

FIG. 2A is a cross-sectional diagram of a carrier for carrying ink cartridges,

FIG. 2B is a diagram showing a magnetic body received in a recess under power-off according to a preferred embodiment of the invention

FIG. 2C is a diagram showing the relative relationship between a magnetic body and a recess under power-on state according to the preferred embodiment of the invention, and

FIG. 3 is a cross-sectional diagram of the carrier for carrying an ink cartridge according to another embodiment of the invention

### DETAILED DESCRIPTION OF THE INVENTION

### First Embodiment

When a user would like to replace an ink cartridge, the invention restricts the user to be able to unload the ink cartridge only when the printer is at a power-on state, that is, when there are currents flowing through the coil. The embodiment of the invention exemplifies how the ink cartridge is coupled to and released from a fastening mechanism when the printer is respectively at a power-off state and the power-on state.

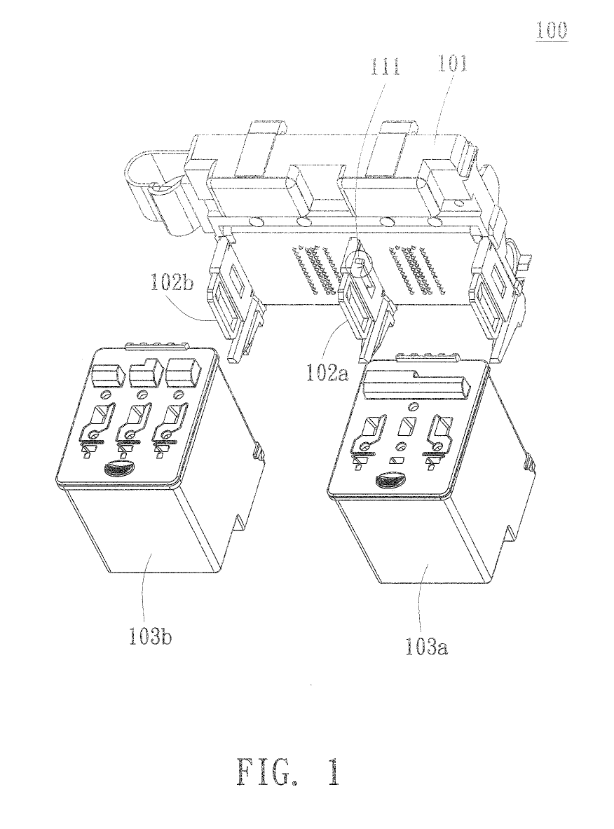

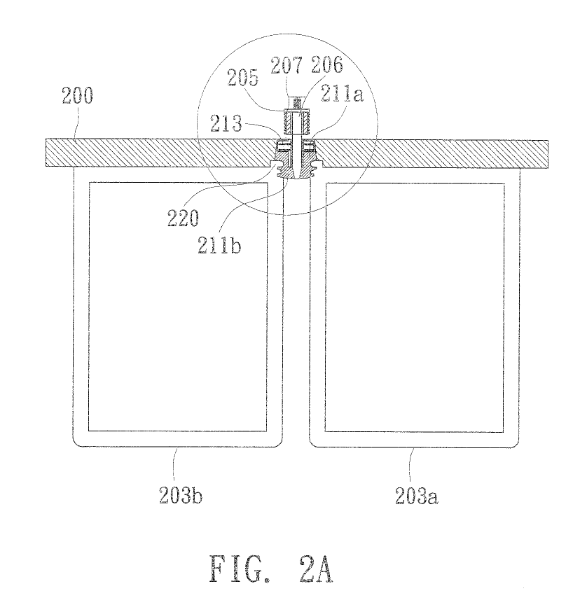

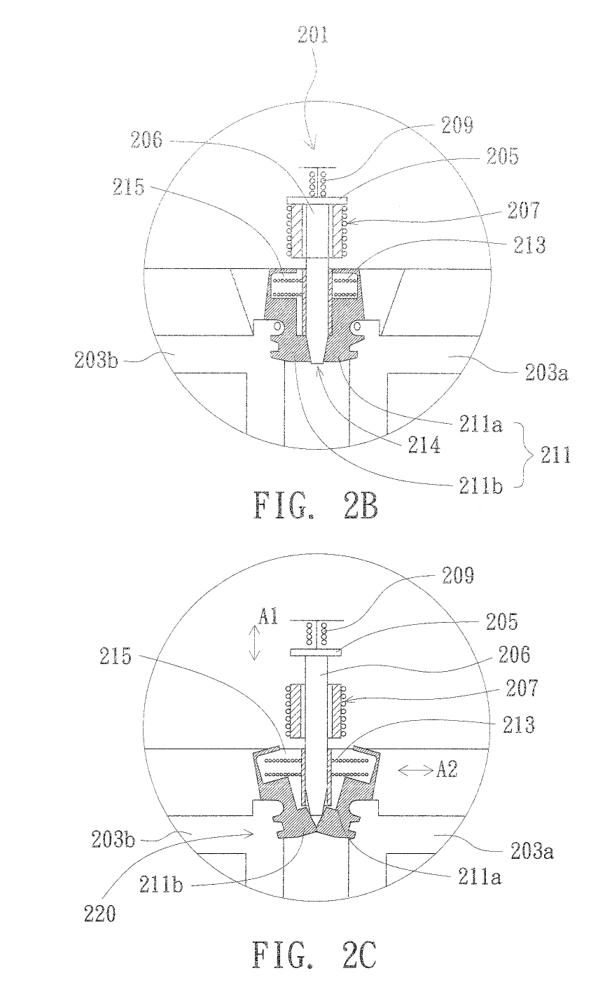

Referring to FIG. 1, a three-dimensional diagram showing the carrier and the ink cartridges of a printer is illustrated, The carrier 100 includes a body 101 and several partitions. The partitions can be partitions 102a and 102b for instance. Different ink cartridges are contained by different partitions, and every two partitions contain an ink cartridge. For example, the partitions 102a and 102b contain the ink cartridge 103b. The partitions 102a has a fastener 111 for preventing the ink cartridge 103a from being unloaded by the user under power-off. Different partitions can be equipped with different fasteners for coupling different ink cartridges. Or, a pair of fasteners can be disposed on a partition for coupling two adjacent ink cartridges. FIGS. 2A to 2G illustrate a preferred embodiment of the invention. In FIGS. 2A to FIG. 2C, two fasteners 211a and 211b are used to couple two ink cartridges 203a and 203b. Referring to FIG. 2A and FIG. 2B. FIG. 2A is a cross-sectional diagram of a carrier for carrying ink cartridges, FIG. 2B is a diagram showing a magnetic body received in a recess under power-off according to a preferred embodiment of the invention. The fastening mechanism 201 of the carrier 200 is used for controlling whether the ink cartridge 203a or 203b can be unloaded or not. The fastening mechanism 201 includes a magnetic body 205, a coil 207, a first elastic member 209, a fastener 211 and a second elastic member 213. In order to optimize the structural design, the magnetic body 205 and a latch 206 are combined and moved together. The carrier 200 has a recess 215 for receiving the latch 206. The fastener 211 includes the fastener 211a and the fastener 211b. The first elastic member 209 is disposed on one end of the magnetic body 205 for providing a resilient energy. The fastener 211 is rotatably disposed on the carrier 200 for enabling the fastener 211 to be correspondingly coupled with the ink cartridge 203a. Under power-off, no current flows through the coil 207, therefore the coil 207 does not generate any magnetic force. The first compressed elastic member 209 releases the resilient energy for pushing the latch 206 into the recess 215. The other end 214 of the latch 206 is wedge-shaped and corresponds to the shape of one end of the fastener 211. Therefore, when the magnetic body 205 is pushed into the recess 215, one end 214 of the latch 206 drives the fastener 211 to rotate and enable the fastener 211 to be tightly coupled with the ink cartridge 203a. Meanwhile, the user is unable to unload the ink cartridge 203a. Similarly, the ink cartridge 203b is unable to be unloaded because the fastener 211a and the fastener 211b are symmetric with respect to the latch 206.

Referring to FIG. 2C, FIG. 2C is a diagram showing the relative relationship between a latch and a recess when the coil 207 is power-on. When the printer is power-on, currents flow through the coil 207 to generate a repelling magnetic force, repelling the magnetic body 205 and enabling the latch 206 connected with the magnetic body 205 to be released from the recess 215. When the latch 206 is released from the recess 215, the fastener 211 is deprived of the fastening force, so the compressed second elastic member 213 releases a resilient energy stored in the second elastic member 213. The resilient energy pushes the fasteners 211a and 211b to rotate to be released from the ink cartridges 203a and 203b. Meanwhile, the user can easily pull the ink cartridges 203a and 203b to separate the coupling portion 220 from the fastener 211. Thus the ink cartridges 203a and 203b can be unloaded along the direction of vertical paper.

In terms of the first elastic member 209, the movement is made mainly along the upward/downward direction A1 to move the magnetic body 205 and the latch 206 together. In terms of the second elastic member 213, the second elastic member 213 is mainly moved along a horizontal direction A2 to rotate the fastener 211. The source of power mainly is supplied when the coil 207 is power-on. When the coil 207 is power-on, a magnetic force mutually excusive with the magnetic body 205 is generated for enabling the magnetic body 205 to resist the first elastic member 209 and compress the first elastic member 209. The force which horizontally resists the second elastic member 213 is generated by using one end of the wedge-shaped latch 206 to drive the fasteners 211a and 211b whose cross-sections are also wedge-shaped. Of course, the corresponding cross-section between the latch 206 and the fasteners 211a and 211b does not have to be wedge-shaped. Any shape of the latch 206 which allows the magnetic body 205 to drive the fastener 211a and 211b so that the coupling portion can be released from the fasteners 211a and 211b is within the scope of the invention. Similarly, during a power-off state, the situations are opposite to the above disclosure.

The number of the fasteners 211a and 211b is determined according to the required number of the ink cartridge 203a or 203b. If the printer only needs one ink cartridge, then one of the fasteners 211a and 211b is disposed in the printer. If the printer needs two or four ink cartridges, then the fasteners are disposed in the printer in pairs.

### Second Embodiment

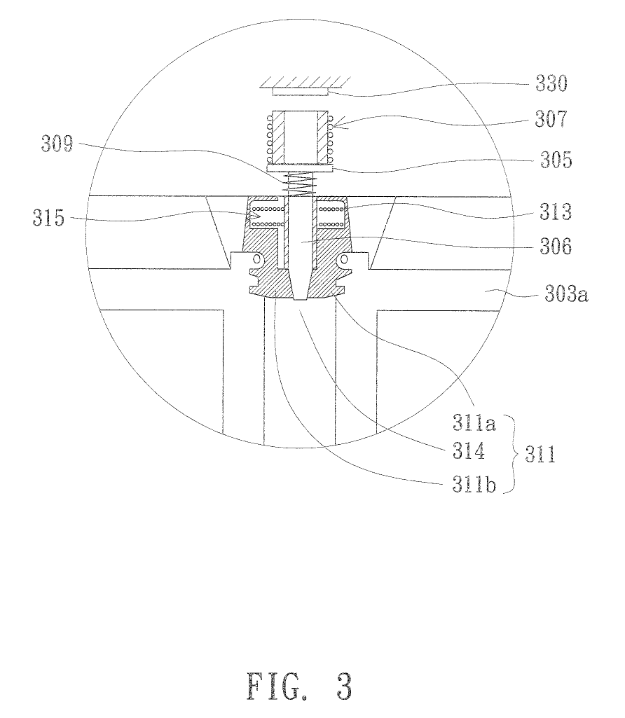

Considering the optimization in the space design, in the previous embodiment of the invention, the coil 207 is fixed and the latch 206 is driven by the magnetic body 205 to move. Or, as shown in FIG. 3, the magnetic body 330 is disposed with respect to the top and the bottom of the coil 307. The magnetic body 330 is fixed, and the coil 307 is designed to be movable and drive the latch 306 to move.

Referring to FIG. 3, when the printer is power-on, there are currents flowing through the coil 307, and a magnetic force is generated when there are currents flowing through the coil 307. The magnetic force attracts the magnetic body 330 for enabling the latch 306 coupled with the coil 307 to be released from the recess 315. Like the preferred embodiment of the invention, when the latch 306 is released from the recess 315, the fastener 311 is deprived of the fastening force, so the compressed second elastic member 313 releases the resilient energy stored in the second elastic member 313. The resilient energy pushes the fasteners 311a and 311b to be rotated and released from the ink cartridges 303a and 303b. To the contrary, when the printer is at a power-off state, there is no current flowing through the coil 307. Therefore, the coil 307 does not generate any magnetic force, and the extended first elastic member 309 releases the resilient energy for inserting the latch 306 into the recess 315. The other end 314 of the latch 306 is wedge-shaped and corresponds to one end of the fastener 311. Therefore, when the latch 306 is inserted into the recess 315, one end 314 of the latch 306 drives the fastener 311 to rotate and enable the fastener 311 to be tightly coupled with the ink cartridge 303a and the ink cartridge 303b.

According to the printer carrier and the fastening mechanism thereof disclosed in above embodiments of the invention, the magnetic force disappears when the coil is at a power-off state and the fastener tightly couples the coupling portion so that the user is unable to unload the ink cartridge. Therefore, the user can only process replacement of ink cartridge during a power-on state. According to the above disclosure, printer will not show error messages in the wake of the replacement of ink cartridge or ink-jet head.

Despite the invention is exemplified by the replacement of the ink cartridge of ink-jet printer, the invention is applicable to the replacement of the carbon toner cartridge of a laser printer,

Besides, the preferred embodiment of the invention separates the fastener from the coupling portion by using the repelling magnetic force with respect to the magnetic body generated when the coil is at a power-on state so that the user to can unload the ink cartridge easily. Anyone who is skilled in the technology can also achieve the object of the invention by the attractive magnetic force with respect to the magnetic body generated when the coil is at a power-on state through a simple transformation. Similarly, in order to optimize the structural design of the embodiment of the invention, the coil 205 is disposed around the magnetic body 207, and the coil also can be disposed on one or two sides of the magnetic body.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A fastening mechanism configured in a carrier of a printer, wherein the carrier comprises a body and a plurality of partitions, an ink cartridge is disposed between every two partitions, the fastening mechanism is for fastening the ink cartridge in the printer, and the fastening mechanism comprises:
a magnetic body disposed in a recess of the carrier;
a coil disposed with respect to the magnetic body, wherein when there are currents flowing through the coil the coil generates an interactive magnetic force with respect to the magnetic body;
at least a fastener movably disposed on the carrier wherein the fastener is used to be correspondingly coupled with the ink cartridge; and
a first elastic member for storing a resilient energy, wherein the resilient energy is used for driving the fastener to move;
wherein when the coil is at a power-on state, the coil generates the magnetic force for enabling the coil and the magnetic body to move relatively and drive the first elastic member to generate a deformation for storing the resilient energy, the fastener is not tightly coupled with the ink cartridge;
wherein when the coil is at a power-off state, the magnetic force generated by the coil disappears and the first elastic member releases the resilient energy for enabling the fastener to be tightly coupled with the ink cartridge.

2. The fastening mechanist according to claim 1, further comprising a latch disposed in the recess, wherein the first elastic member is disposed on one end of the magnetic body, and the latch and the magnetic body are moved together to compress the first elastic member when the coil is at the power-on state.

3. The fastening mechanism according to claim 2, further comprising a second elastic member disposed on two sides of the latch.

4. The fastening mechanism according to claim 3, wherein when the coil is at the power-on state, the fastener is rotated by the elastic force of the second elastic member for releasing the ink cartridge from the fastener.

5. The fastening mechanism according to claim 4, wherein a first cross-sectional shape of the fastener corresponds to a second cross-sectional shape of the latch.

6. The fastening mechanism according to claim 5, wherein the first cross-sectional shape of the fastener and the second cross-sectional shape of the latch are both wedge-shaped.

7. The fastening mechanism according to claim 2, wherein the coil is disposed around the latch.

8. The fastening mechanism according to claim 1, further comprising a latch disposed on the recess, wherein the latch and the coil move together, the first elastic member is coupled to one end of the latch, and the latch extends the first elastic member when the coil is at the power-on state.

9. The fastening mechanism according to claim 8, wherein the magnetic body is disposed with respect to the top and the bottom of the coil.

10. A carrier configured in a printer, wherein the carrier comprises:
a body;
a plurality of partitions formed on the body, wherein an ink cartridge is disposed between every two partitions; and
at least a fastening mechanism disposed on the partitions, wherein the fastening mechanism comprises:
a magnetic body disposed in a recess of the carrier;
a coil disposed with respect to the magnetic body, wherein when there are currents flowing through the coil, the coil generates an interactive magnetic force with respect to the magnetic body;
at least a fastener rotatably disposed on the carrier, wherein the fastener is used to be correspondingly coupled with the ink cartridge; and
a first elastic member for storing a resilient energy, wherein the resilient energy is used for driving the fastener to move;
wherein when the coil is at a power-on state, the coil generates the magnetic force for enabling the coil and the magnetic body to move relatively and drive the first elastic member to generate a deformation for storing the resilient energy, the fastener is not tightly coupled with the ink cartridge;
wherein when the coil is at a power-off state the magnetic force generated by the coil disappears and the first elastic member releases the resilient energy for enabling the fastener to be tightly coupled with the ink cartridge.

11. The carrier according to claim 10, wherein the fastening mechanism further comprises a latch disposed in the recess, the first elastic member is disposed on one end of the magnetic body, and the latch and the magnetic body are moved together to compress the first elastic member when the coil is at the power-on state.

12. The carrier according to claim 11, wherein the fastening mechanism further comprises a second elastic member disposed on the two sides of the latch.

13. The carrier according to claim 12, wherein when the coil is at the power-on state, the fastener is rotated by the elastic force of the second elastic member for releasing the ink cartridge from the fastener.

14. The carrier according to claim 13, wherein a first cross-sectional shape of the fastener corresponds to a second cross-sectional shape of the latch.

15. The carrier according to claim 14, wherein the first cross-sectional shape of the fastener and the second cross-sectional shape of the latch are both wedge-shaped.

16. The carrier according to claim 15, wherein the coil is disposed around the latch.

17. The carrier according to claim 10, wherein the fastening mechanism further comprises a latch disposed on the recess, the latch and the coil move together, the first elastic member is coupled to one end of the latch, and the latch extends the first elastic member when the coil is at a power-on state.

18. The carrier according to claim 17, wherein the magnetic body is disposed with respect to the top and the bottom of the coil.
